(19) United States
(12) Patent Application Publication
(10) Pub. No.: US 2011/0246512 A1
(43) Pub. Date: Oct. 6, 2011

(54) SYSTEM AND METHOD FOR A REMOTELY ACCESSIBLE WEB-BASED PERSONAL ADDRESS BOOK

(75) Inventors: DAN LUBARSKI, WATERTOWN, MA (US); SERGEY PORFIRIEV, NEWTON, MA (US)

(73) Assignee: HUMANBOOK, INC, WELLESLEY HILLS, MA (US)

(21) Appl. No.: 13/118,527

(22) Filed: May 30, 2011

Related U.S. Application Data
(63) Continuation-in-part of application No. 12/342,932, filed on Dec. 23, 2008.
(60) Provisional application No. 61/350,228, filed on Jun. 1, 2010.

(51) Int. Cl. G06F 17/30

(52) U.S. Cl. 707/769; 707/E17.014

(57) ABSTRACT

A computer implemented method for providing a remotely accessible web-based address book includes the following steps. First, a user registers with a web-server and sets up an account. The web-server is configured to generate, store and provide access services to web-based address books. Next, the user uploads personal address book information and contacts in the account. Next, the web-server generates a personal web-based address book for the user based on the address book information and contacts and then adds voice tags and text tags to each entry in the user's personal web-based address book. Next, the web-server cross-correlates and matches the uploaded names and contact information of the user's personal contacts with information in other users' profiles stored in a central directory database. If a match exists between one of the uploaded user's personal contacts and a pre-existing user's profile in the central directory database, the web-server updates the pre-existing user's profile in the central directory database. If a match does not exist, the web-server generates a new user's profile in the central directory database. Next, the user accesses the personal web-based address book by placing a phone-call via a voice transmitting connection. Next, the web-server verifies the user's identity. Next, the user selects a personal contact in the user's personal web-based address book and the web-server places a phone-call to the selected personal contact.

### CROSS REFERENCE TO RELATED CO-PENDING APPLICATIONS

This application claims the benefit of U.S. provisional application Ser. No. 61/350,228 filed on Jun. 1, 2010 and entitled SYSTEM AND METHOD FOR A REMOTELY ACCESSIBLE WEB-BASED PERSONAL ADDRESS BOOK which is commonly assigned and the contents of which are expressly incorporated herein by reference.

This application is a continuation-in-part and claims the benefit of U.S. application Ser. No. 12/342,932 filed on Dec. 23, 2008 and entitled SYSTEM AND METHOD FOR A WEB-BASED ADDRESS BOOK which is commonly assigned and the contents of which are expressly incorporated herein by reference.

### FIELD OF THE INVENTION

The present invention relates to a system and a method for a remotely accessible web-based personal address book, and in particular to a web-based personal address book that allows worldwide remote access of the listed contact information via a voice transmitting connection.

### BACKGROUND OF THE INVENTION

A person uses address books for storing and maintaining contact information for people belonging to the person's social network. Address books include lists of names and addresses (home, business, school, seasonal, temporary), phone numbers, e-mail addresses, web-site information, instant messaging information, online identification and other vital information such as birthdays, hobbies, education, preferences, pictures and stories, associated with the listed names. Address books may have the form of a physical printed book or may be digital files stored in servers, personal digital assistants (PDA), phones, or other computing or communications devices, or may be online address books. Online address books invite people to register in a website and then upload contact information for people belonging to their personal and business network. One such example is “The Internet Address Book” at www.internetaddressbook.com. This website also allows the users to search the web for the contact information of people belonging to a person's network, actively manage a person's contact information, i.e., edit, update, add or delete, and discover other people's social network. A name based search usually involves searching online social network groups for information pertaining to the name of the person being searched. Examples of social network groups include www.Facebook.com, www.MySpace.com, www.friendster.com, www.linkedIn.com, www.Zoominfo.com, www.Flickr.com, www.ICQ.com, www.Buzznet.com, www.Xanga.com and online alumni network of people who attended a specific college or university. These social network groups allow a user to create a personal profile, store it in the social network's database and publish it to the group. The published information is usually not verified by a third party and may be fictitious. A group member accesses his profile by logging into the group's website via a user identification and password and enters and/or modifies his profile information content. Access to the user's profile by other network members is controlled by the user. These prior art systems rely upon each group member actively managing and updating his online profile content and contact information. However, this usually does not happen. Therefore the retrieved contact information may be wrong, outdated and in general not reliable.

Furthermore, accessing an online personal address book usually requires specific equipment or networks. In some situations, it is inconvenient, unavailable or too expensive to access a personal online address book via the Internet. For example, when traveling internationally, there are places without Internet access or they require high fees for accessing the Internet.

Accordingly, there is a need for a system and method that provides inexpensive access to a personal online address book even in situations where there is no web-access available.

### SUMMARY OF THE INVENTION

A system and a method for a web-based personal address book that allows worldwide remote access of the listed contact information via a voice transmitting connection and device. The voice transmitting connection may be one of local or long distance telephone connection, toll-free telephone connection, VOIP connection, broadband connection, satellite connection, wired or wireless connections.

In general, in one aspect, the invention features a computer implemented method for providing a remotely accessible web-based address book including the following steps. First, a user registers with a web-server and sets up an account. The web-server is configured to generate, store and provide access services to web-based address books. Next, the user uploads personal address book information and contacts in the account. Next, the web-server generates a personal web-based address book for the user based on the address book information and contacts and then adds voice tags and text tags to each entry in the user's personal web-based address book. Next, the web-server cross-correlates and matches the uploaded names and contact information of the user's personal contacts with information in other users' profiles stored in a central directory database. If a match exists between one of the uploaded user's personal contacts and a pre-existing user's profile in the central directory database, the web-server updates the pre-existing user's profile in the central directory database. If a match does not exist, the web-server generates a new user's profile in the central directory database. Next, the user accesses the personal web-based address book by placing a phone-call via a voice transmitting connection. Next, the web-server verifies the user's identity. Next, the user selects a personal contact in the user's personal web-based address book and the web-server places a phone-call to the selected personal contact.

Implementations of this aspect of the invention may include one or more of the following features. The voice transmitting connection may be a toll-free telephone connection, local telephone connection, long-distance telephone connection, Voice over Internet Protocol (VOIP) telephone connection, broadband connection, satellite connection, wired connection or wireless connection. The user's identity is verified via a caller id or a pin-based authentication. The registering includes providing, a name, phone number, and payment information. The personal address book information is uploaded from one or more of mobile phones, smart phones, personal digital assistants (PDAs), websites, servers, computers, or manually. The method further includes automatically updating the user's personal web-based address book by the web-server based on future updates and entries in the central directory database. The user selects a personal contact in the personal web-based address book via an interactive voice response (IVR) system. The method further includes providing directory information by dialing a toll-free number. The user's account includes name, password, personal identification number (PIN), caller id, phone number, payment information, credit card information, bank account information, address, e-mail, and current location. The personal address book information for each contact includes name, phone number, e-mail, address, and current location. The method further includes verifying and updating a user's profile information in the central directory database by other users. The method further includes inviting the user's personal contacts to verify information in their personal profile and then generate and upload their personal address books.

In general, in another aspect, invention features a system for a remotely accessible web-based address book. The system includes a web-server configured to generate, store and provide access services to web-based address books, a central directory database configured to store users' profiles, and an address book application. The address book application includes means for registering and setting up an account for a user, means for uploading personal address book information and contacts in the account by the user, means for generating a personal web-based address book for the user based on the address book information and contacts by the web-server, means for adding voice tags and text tags to each entry in the user's personal web-based address book by the web-server. The system further includes means for accessing the personal web-based address book by the user by placing a phone-call via a voice transmitting connection, means for verifying a user's identity by the web-server, and means for selecting a personal contact in the user's personal web-based address book by the user and placing a phone-call to the selected personal contact via the web-server.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is an overview diagram of a web-based address book system, according to this invention;

FIG. 2 is a schematic diagram of the common address book of FIG. 1;

FIG. 3 depicts a profile template as stored in the common address book of FIG. 1;

FIG. 4 illustrates the process of creating the collaborative web-based address book of this invention;

FIG. 5 is a schematic diagram of the stored personal profile information; and

FIG. 6 is a flow diagram of the process of accessing the web-based address book system of FIG. 1 via a toll-free phone communication.

### DETAILED DESCRIPTION OF THE INVENTION

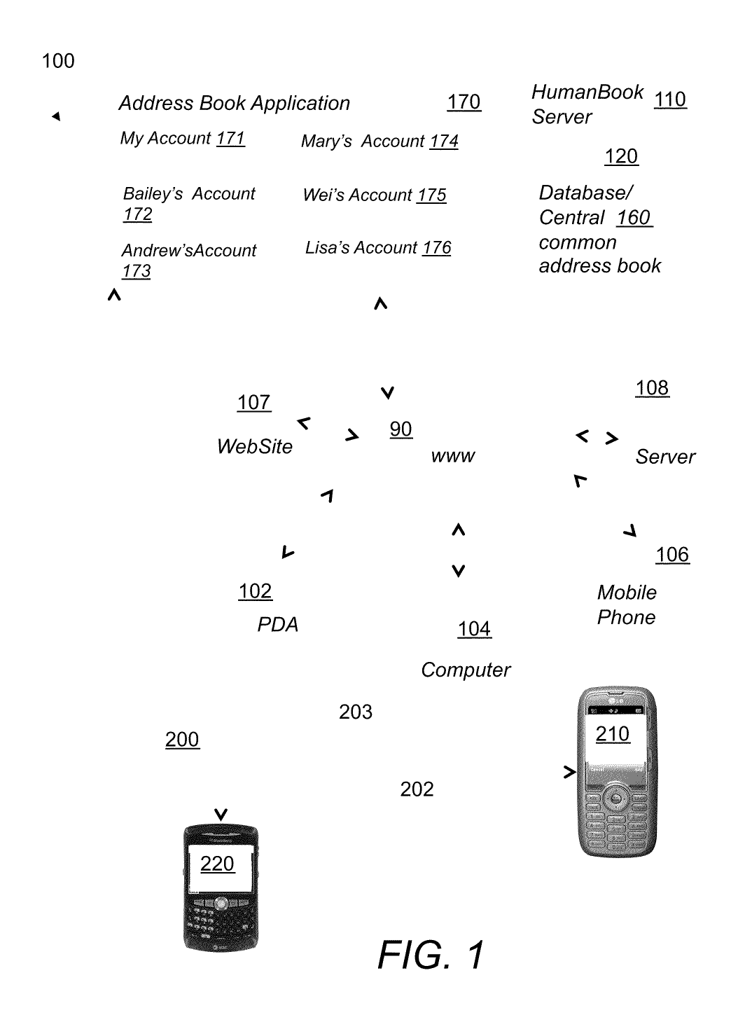

Referring to FIG. 1, a web-based address book 100 system includes a server 110, a central common address book/database 120, an address book application 170 and communication devices/systems 102, 104, 106, 107 and 108. The communication devices/systems include a Personal Digital Assistant (PDA) 102, a computer 104, a mobile phone 106, server 108 and a website 107 running on a server. In other examples, the communication devices may be wired or wirelesses devices including a pager, a wireless laptop computer, a personal computer, a television remote control, servers, or combinations thereof. The communication devices access the server 110, address book application 170 and database 120 via a network connection 90. In one example, network connection 90 is the Internet. In other examples, the network connection 90 may be a phone network, a cable network, or other wireless or a wired networks. In this embodiment, address book application 170 and central common address book 120 are stored in storage systems within the server 110. In other embodiments, address book application 170 and central common address book 120 are stored in separate servers or storage devices. The system also includes mobile phones 210 and 220. Mobile phone 210 accesses the online web-based address book 100 system via a toll-free phone call 202 to communication server 200. Communication server 200 receives the toll-free phone call 202 from mobile phone 210 and provides access to the user's personal account/address book 171 stored in the online web-based address book 100 system. Communication server 200 also provides a response to a user's request for specific contact information, phone number or e-mail address of a particular contact in the user's personal account/address book 171 and then facilitates a phone connection (or e-mail connection) 203 to the mobile phone 220 of the requested contact. In other embodiments, a user accesses his web-based personal address book remotely via any type of voice transmitting connection and device. The voice transmitting connection and device may be a local or long distance telephone connection/device, toll-free telephone connection/device, VOIP connection/device, broadband connection/device, satellite connection/device, or any other wired or wireless connection/device.

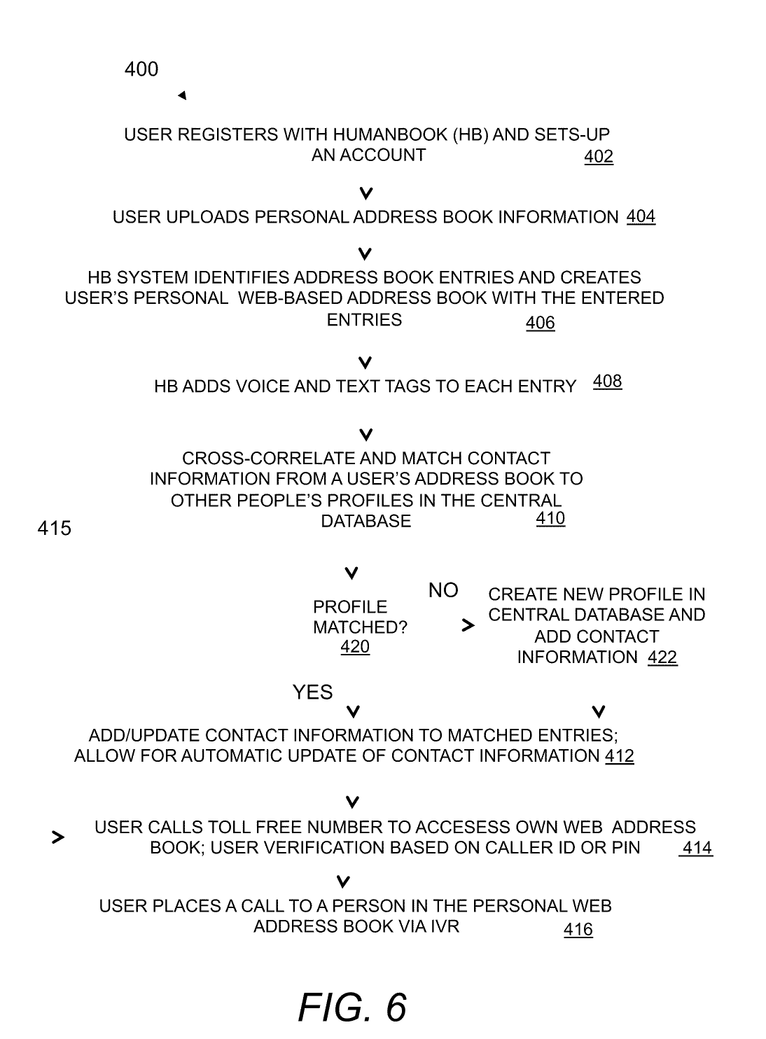

Referring to FIG. 6, the process 400 for creating an online personal account/address book 171 in the web-based address book 100 and then using the account to place phone calls to contacts whose information is stored in the online account 171 includes the following. First a user registers with the Humanbook server 110, starts the address book application 170 and sets-up a personal account 171 (My Account) (402). The user registration includes at least providing a name, phone number and payment information, such as credit card or ACH banking information. Next, the user uploads his personal address book information (404) from external sources to the created personal account 171. The external sources include mobile phones 106, smart phones/PDAs 102, websites 107, servers 108 or a computer 104, among others. The smart phone 102 may be an iPhone, a Blackberry, or any other mobile phone. The source file may be an Outlook Express file or a ThunderBird file stored in a computer 104, among others. The source website account may be gmail, yahoo, facebook, linkedin, among others. Next, the web-based address book system 100 identifies each entry in the uploaded user's personal address file and automatically creates a user's web-based address book with entries corresponding to the user's personal address book entries (406). Next, system 100 adds voice and text tags to each entered entry (408) and then cross-correlates, matches and links all entries to entries in the central common address book/database 160 (410). If there is a profile match the contact information is added, and or updated (412). This process also provides for automatic updating of the contact's information based on future updates and corrections in the central common address book/database 160. If there is no profile match, the system creates a new profile in the central common address book/database 160 and adds the contact's information (422). In other embodiments, the user enters manually his personal contacts and their contact information in his personal address book/account 171. If these manually entered contacts do not already exist in the central common address book/database 160, they are also entered in the central common address book/database 160 by the system. In yet other embodiments, the user searches the central common address book/database 160, identifies his personal contacts and transfers these contacts and their contact information in his personal address book/account 171. Next, the user accesses his own address book in his account 171 by dialing one or more tool-free access numbers. These tool-free access numbers provide worldwide access to a person's personal web-based address book. After dialing the tool-free access number, the user is verified via a PIN or via a caller ID (414). Next, the system 100 asks the user which record he would like to retrieve: “Please say a name of a person you wish to call”. The user replies: “Call Lisa Chen” and the system dials Lisa Chen's number and connects to the user (416). In one example, the system utilizes an interactive voice response (IVR) system for this process. The user's credit card or ACH is charged based on the rates and minutes used for the phone call. The system 100 also provides directory information to users by dialing 411. In other embodiments, a user accesses his web-based personal address book remotely via any type of voice transmitting connection and device. The voice transmitting connection may be a local or long distance telephone connection, toll-free telephone connection, VOIP connection, broadband connection, satellite connection, or any other wired or wireless connection.

In another embodiment, the system 100 does not include cross-correlation, matching and automatic updating of the contact information stored in the user's personal web-based address book. In this embodiment, the user uploads his personal address book information (404) and the system creates a personal web-based address book for the user (406). Next, the user accesses his personal address book/account 171 by dialing one or more tool-free access numbers (415). These tool-free access numbers provide worldwide access to a person's personal web-based address book. After dialing the tool-free access number, the user is verified via a PIN or via a caller ID (414). Next, the system 100 asks the user which record he would like to retrieve: “Please say a name of a person you wish to call”. The user replies: “Call Lisa Chen” and the system dials Lisa Chen's number and connects to the user (416). Examples of personal web-based address books that can be accessed via a toll-free number include “The Internet Address Book” at www.internetaddressbook.com, www.Facebook.com, www.MySpace.com, www.friendster.com, www.linkedIn.com, www.Zoominfo.com, www.Flickr.com, www.ICQ.com, www.Buzznet.com, www.Xanga.com and online alumni networks of people who attended a specific college or university, among others. Again in this embodiment, a user accesses his web-based personal address book remotely via any type of voice transmitting connection and device. The voice transmitting connection may be a local or long distance telephone connection, toll-free telephone connection, VOIP connection, broadband connection, satellite connection, or any other wired or wireless connection.

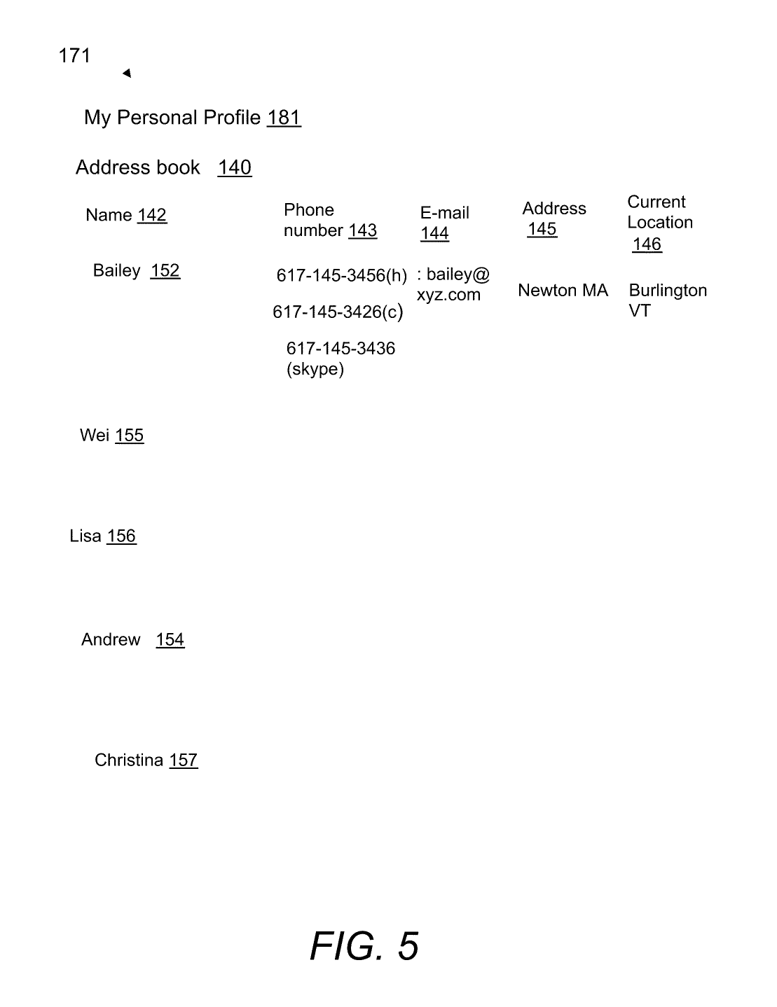

Referring to FIG. 5, a user's account 171 includes the user's personal account information 181 and the user's personal address book 140. The personal account information includes the user's name, password, PIN, caller ID, phone number, payment information, credit card information, bank account information, address, e-mail and current location, among others. The personal address book 140 includes the name of a person 142, phone numbers 143, e-mail 144, address 145 and current location 146. Phone numbers 143 may be home, cellphone, work, Skype numbers, among others.

Accessing personal web-based address books via a toll-free phone connection provides world-wide access to a person's address book even in cases where there is no Internet connection, cell-phone with died batteries, no personal cellphone, very large address books or shared address books. The system provides low cost worldwide access to a person's address books via a local toll-free phone connection. This is particularly useful for people traveling worldwide because it allows them to access their address book at any time, from any type of a phone by dialing a low cost local toll-free access number. The system 100 also provides directory information to users by dialing 411 worldwide.

The central common address book 160 is created by the system administrator and stored in the server 110. This central common address book 160 is the integrator of every person's profile, list of contacts (address books) and the distributor of people's contacts to every person. The contact information is stored in the server and is updated by people in real time.

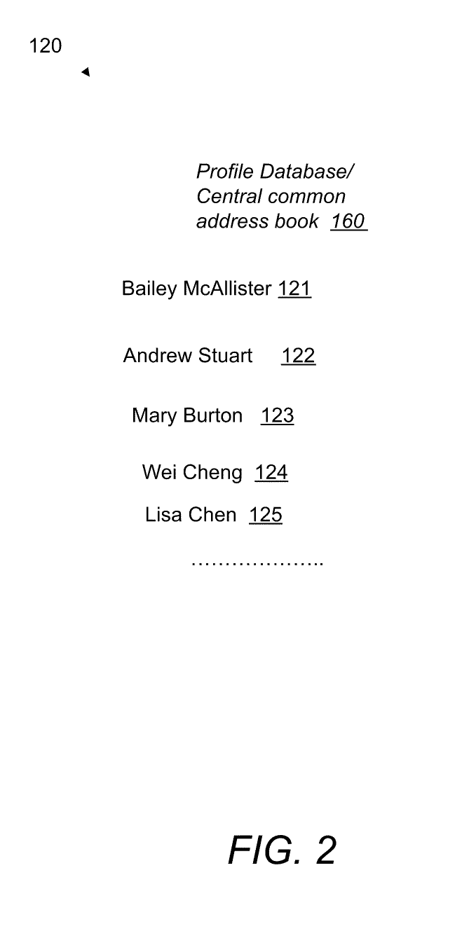

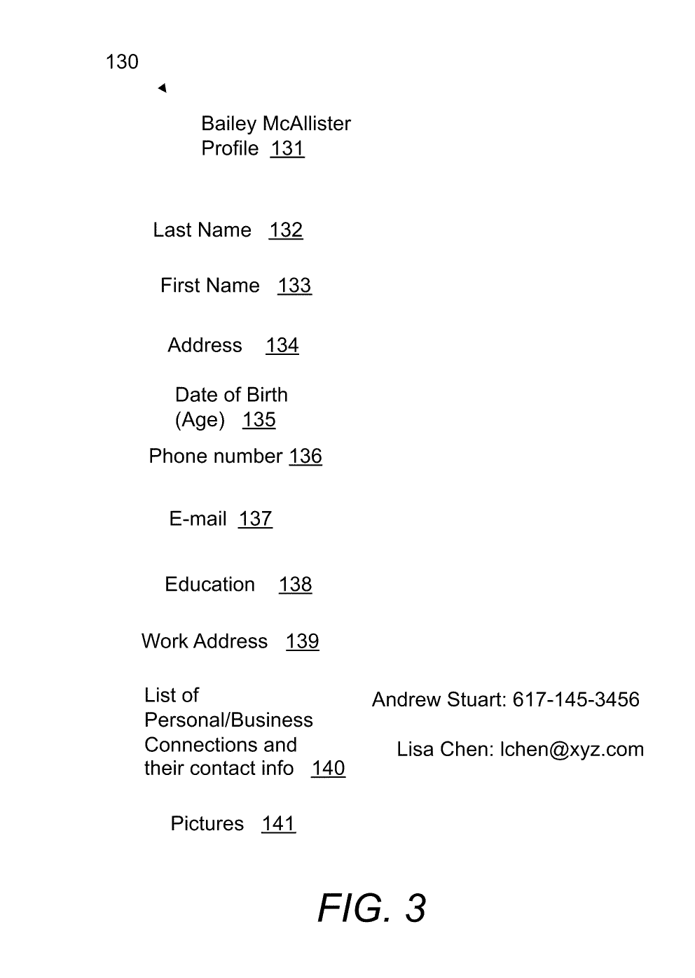

Referring to FIG. 2, central common address book/database 160 includes personal data profiles of people. Examples of people whose profiles are listed in database 160 are people residing in a certain geographic area or people belonging to a certain organization or group, or in general all people on earth. Database 160 also includes profiles of entities including businesses, educational institutions and organizations, among others. For every person or entity the system has a unique index preset and empty fields preserved for all attributes related to that person or entity. Even if a person had never logged into the system, his profile still exists and other people can link to it and leave contact info of that person in his profile. Referring to FIG. 3, the profile for Bailey McAllister 130 includes the unique preset index 131 and parameter fields for last name 132, first name 133, address 134, date of birth or age 135, phone number 136, education 138, work address 139, pictures 141, and lists of personal and business contacts 140, i.e., personal address book, among others. Basic information for each profile is preloaded by the system administrator based on publicly available data. The basic information is defined as information sufficient for identifying and matching a specific person with a specific profile. In one example, the basic information is a name and/or any of the other mentioned parameters. Publicly available data include data from phone directories, business directories, marketing data and financial data, among others. The basic profile information is published and then other people including the person to whom the profile belongs contribute, edit and modify the profile information. This unique feature of the system allows people to share knowledge about a person and record it to preset database fields of the person's profile. The profile index and the individual profile fields have unique locations, which can be searched and easily found. The system is self updated and the information is always current because people contribute to it and edit it. Since every piece of information has a unique location—once somebody changes it, all people can see the updated information because everyone is linked to the same index field of information. This web-based people directory system is a Web 2.0 website that combines the online social network attributes with the ability to contribute content and information while allowing users to exercise control over their data. Web 2.0 websites refer to web-based communities and hosted services, which facilitate creativity, collaboration and sharing between users. A more detailed discussion of Web 2.0 websites is presented in Wikipedia http://en.wikipedia.org/wiki/Web_{—}2, the contents of which are incorporated herewith.

The contact information in the web-based address book system is organized and is matched and linked to real people's profiles. In the example of FIG. 3, Bailey McAllister is the owner of an address book 140 (i.e., list of connections and their contact information) that includes the names of Andrew Stuart and Lisa Chen, as her connections. For Andrew Stuart a phone number is listed and for Lisa Chen an e-mail address is listed. The system matches Andrew Stuart's phone number as listed in Bailey McAllister's address book 140 to his personal preexisting profile 122 in database 120, shown in FIG. 2, and enters it into his profile phone number field 136. Similarly Lisa Chen's e-mail address is matched to her preexisting profile 125 in database 120, shown in FIG. 2, and entered into her profile e-mail information field 137. People whose contact information is uploaded by others and have not joined the service or activated their personal profile, are invited to join the service and fill in their profile information. This matching and cross-correlation of contact information is performed by the system administrator or the users of the system. In other examples an automatic tool matches the uploaded contact information to people's profiles.

Thus people invite other people to join this web-based address book service using the provided contact information. It is a promotional chain wave. The more people use the system and the more profiles are active, the better and more reliable services this system offers. A matrix of contact information is being formed.

Contact information, uploaded by many, is shared and a common address book is created. The common address book is usually updated in real time, enriched with additional data and new contacts. If profiles of two or more people are linked together, then it is implied that these two or more people share the contact information of each other. Access to the contact information of each other is granted according to contact owners' preferences. Users can manage their contact information access preferences and who, out of the connected profiles, can get their current contact info. If a profile was not visited by its owner and access preferences were not set, then default settings are in place. If contact info is not shared and not available to other users, other users can leave a message for that person on the system.

If any contact information changes, i.e. gets updated by another person or if a profile owner changes his own contact information, this change automatically updates the profile owner's contact information on all other users' contact books, which were linked to this profile. In this way a person's contact information is current and gets updated in real time.

People can also get the contact information of someone, whom they don't personally know, but want to contact, if the contact information is shared by somebody, who has contact access privileges. This system make is easy to communicate and network with other people and make new connections.

Updated contact information is distributed to authorized people and is available anytime for download or for usage on site. Special tools allow synchronization and export of information from the updated central address book to address books stored in people's client devices, such as mobile phones, PDAs, personal computers and pagers, among others.

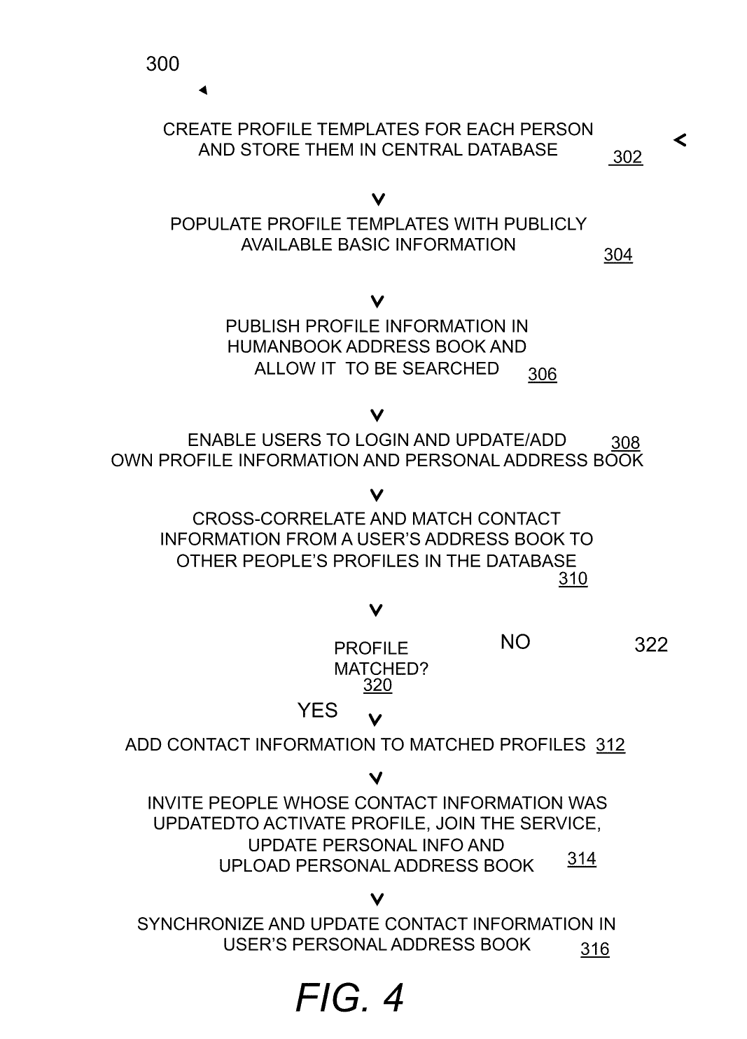

Referring to FIG. 4, the process 300 for generating the web-based common address book 120 includes the following steps. First, creating profile templates for each person on earth and storing these profile templates in a central database (302). Next, populating the profile templates with publicly available basic information (304) and then publishing the public profile information in the web-based address book (306) and allowing it to be searched. Users are allowed to login into the address book website, update their own profile information and upload their personal address book (308). Next, the system cross-correlates and matches contact information retrieved from users' personal address books to other people's profiles in the database (310). This matching of the contact information to a person's profile is done automatically or manually by the user or the administrator. If a profile match is found (320) the contact information is added to the matched profile (312). The person whose contact information was added is invited to activate his profile, join the service, update personal profile information and upload personal address book (314). The invitation may be sent by the system administrator, the user from whose address book the contact information was retrieved or any other user. All submissions are eponymous and can be traced back to the originator of the information. Finally the system synchronizes and updates the entered/updated contact information is in all users' personal address books (314). If a profile match was not found in step 320 a new profile is created and added in the database (322). The system is governed by rules that do not allow publishing of negative information in a profile, i.e., all published information is positively bound. All profile information entries are verified either by other members of the community to which the specific person belongs or by answering preset questions formulated based on common knowledge. In one example, a person's attendance of a particular school is verified based on answering a question about a teacher who taught at the particular school during the time period of reference. In this example, the question may be either the name of the teacher or subject matter taught by the teacher, or a specific event that happened in the teacher's presence.

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for providing a remotely accessible web-based address book comprising:
registering with a web-server and setting up an account by a user, wherein said web-server is configured to generate, store and provide access services to web-based address books;
uploading personal address book information and contacts in said account by the user;
generating a personal web-based address book for said user based on said address book information and contacts by the web-server;
adding voice tags and text tags to each entry in said user's personal web-based address book by the web-server;
cross-correlating and matching the uploaded names and contact information of the user's personal contacts with information in other users' profiles stored in a central directory database;
if a match exists between one of the uploaded user's personal contacts and a pre-existing user's profile in the central directory database, updating said pre-existing user's profile in the central directory database;
if a match does not exist, generating a new user's profile in the central directory database;
accessing the personal web-based address book by the user by placing a phone-call via a voice transmitting connection;
verifying user's identity by the web-server; and
selecting a personal contact in the user's personal web-based address book by the user and placing a phone-call to the selected personal contact via the web-server.

2. The computer implemented method of claim 1, wherein said voice transmitting connection comprises one of toll-free telephone connection, local telephone connection, long-distance telephone connection, Voice over Internet Protocol (VOIP) telephone connection, broadband connection, satellite connection, wired connection or wireless connection.

3. The computer implemented method of claim 1, wherein said user's identity is verified via a caller id or a pin-based authentication.

4. The computer implemented method of claim 1, wherein said registering comprises providing, a name, phone number, and payment information.

5. The computer implemented method of claim 1, wherein said personal address book information is uploaded from one or more of mobile phones, smart phones, personal digital assistants (PDAs), websites, servers, computers, or manually.

6. The computer implemented method of claim 1, further comprising automatically updating said user's personal web-based address book by the web-server based on future updates and entries in the central directory database.

7. The computer implemented method of claim 1, wherein said user selects a personal contact in the personal web-based address book via an interactive voice response (IVR) system.

8. The computer implemented method of claim 1, further comprising providing directory information by dialing a toll-free number.

9. The computer implemented method of claim 1, wherein said user's account comprises name, password, personal identification number (PIN), caller id, phone number, payment information, credit card information, bank account information, address, e-mail, and current location.

10. The computer implemented method of claim 1, wherein said personal address book information for each contact comprises name, phone number, e-mail, address, and current location.

11. The computer implemented method of claim 1, further comprising verifying and updating a user's profile information in said central directory database by other users.

12. The computer implemented method of claim 1, further comprising inviting said user's personal contacts to verify information in their personal profile and then generate and upload their personal address books.

13. A system for a remotely accessible web-based address book comprising:
a web-server configured to generate, store and provide access services to web-based address books;
a central directory database configured to store users' profiles;
an address book application comprising means for registering and setting up an account for a user, means for uploading personal address book information and contacts in said account by the user, means for generating a personal web-based address book for said user based on said address book information and contacts by the web-server, means for adding voice tags and text tags to each entry in said user's personal web-based address book by the web-server;
means for accessing the personal web-based address book by the user by placing a phone-call via a voice transmitting connection;
means for verifying a user's identity by the web-server; and
means for selecting a personal contact in the user's personal web-based address book by the user and placing a phone-call to the selected personal contact via the web-server.

14. The system of claim 13, wherein said address book application further comprises means for cross-correlating and matching the uploaded names and contact information of the user's personal contacts with information in other users' profiles stored in the central directory database, means for updating pre-existing user's profile in the central directory database, if a match exists between one of the uploaded user's personal contacts and the pre-existing user's profile, and means for generating a new user's profile in the central directory database, if a match does not exist.

15. The system of claim 13, wherein said voice transmitting connection comprises one of toll-free telephone connection, local telephone connection, long-distance telephone connection, Voice over Internet Protocol (VOIP) telephone connection, broadband connection, satellite connection, wired connection or wireless connection.

16. The system of claim 13, wherein said means for verifying a user's identity comprises a caller id or a pin-based authentication.

17. The system of claim 13, wherein said personal address book information is uploaded from one or more of mobile phones, smart phones, personal digital assistants (PDAs), websites, servers, computers, or manually.

18. The system of claim 13, wherein said address book application further comprises means for automatically updating said user's personal web-based address book based on future updates and entries in the central directory database.

19. The system of claim 13, wherein said means for selecting a personal contact in the user's personal web-based address comprise an interactive voice response (IVR) system.

20. The system of claim 13, further comprising means for providing directory information by dialing a toll-free number.

21. The system of claim 13, wherein said user account comprises name, password, personal identification number (PIN), caller id, phone number, payment information, credit card information, bank account information, address, e-mail, and current location.

22. The system of claim 13, wherein said personal address book information for each contact comprises name, phone number, e-mail, address and current location.

23. The system of claim 13, wherein said address book application further comprises means for verifying and updating a user's profile information in said central directory database by other users.

24. The system of claim 13, wherein said address book application further comprises means for inviting said user's personal contacts to verify information in their personal profile and then generate and upload their personal address books.
